(19) United States
(12) Patent Application Publication
(10) Pub. No.: US 2018/0115184 A1
(43) Pub. Date: Apr. 26, 2018

(54) WIRELESS CHARGING ADAPTER

(71) Applicant: JOHN YAO-TING LEE, TAIPEI (TW)

(72) Inventor: JOHN YAO-TING LEE, TAIPEI (TW)

(21) Appl. No.: 15/695,449

(22) Filed: Sep. 5, 2017

(30) Foreign Application Priority Data
Oct. 24, 2016 (TW) 105134211

(51) Int. Cl. H02J 7/02; H02J 7/00

(52) U.S. Cl. CPC H02J 7/025; H02J 7/0044

(57) ABSTRACT

A wireless charging adapter, comprising: a main body; a receiver, which is disposed in the main body and is provided to receive a first charging magnetic field of a first wireless charging standard from the outside of the main body and convert the first charging magnetic field to a charging energy; and a transmitter, which is disposed in the main body and electrically connected to the receiver, being provided to convert the charging energy to a second charging magnetic of a second wireless charging standard and transmit the second charging magnetic field to the outside of the main body, wherein the first wireless charging standard is different from the second wireless charging standard, so as to charge a electronic device when the wireless charging standards used by the electronic device and a wireless charger do not match.

### TECHNICAL FIELD

The present invention relates to a wireless charging peripheral device, and more particularly to a wireless charging adapter.

### BACKGROUND

With rapid advancement of technology, there are more and more electronic devices utilizing wireless charging techniques. There are several different alliances formed by different wireless charging companies, and each alliance has released its wireless charging standard such as Qi, PMA, A4WP, Rezence and AirFuel, to compete with other alliances.

However, these wireless charging standards are not compatible with each other. A wireless charger (transmitter) configured for a certain wireless charging standard can not charge an electronic device (receiver) configured for another wireless charging standard such that a non-chargeable environment still remains, which will limit the usage of the electronic device and lose the convenience of wireless charging. Therefore, it is necessary to provide a wireless charging adapter that can solve the problem of non frequency and protocol compatibility between the electronic receiving device and the wireless chargers with different and non matching wireless charging standards.

### SUMMARY

Accordingly, an object of the present invention is to provide a wireless charging adapter, which enables a wireless charger (transmitter) to charge an electronic device (built-in receiver) even though the wireless charging standard of the electronic device does not match the wireless charging standard of the wireless transmitter.

To solve the issues in the prior art, the present invention provides a wireless charging adapter, comprising: a main body; a receiver, which is integrated in the main body and is provided to receive a first charging magnetic field via coil or antenna or whatever other means from the outside of the main body by following a first wireless charging standard to convert the first charging magnetic field to a charging energy; and a transmitter, which is integrated in the main body and electrically connected to the receiver, being provided to convert the charging energy to a second charging magnetic field by following a second wireless charging standard and transmit the second charging magnetic field to the outside of the main body, wherein the first wireless charging standard is different from the second wireless charging standard.

According to an embodiment of the present invention, the wireless charging adapter further comprises a battery which is electrically connected to the receiver and the transmitter so as to store the charging energy and provide the stored charging energy to the transmitter.

According to an embodiment of the present invention, the receiver is provided to receive the first charging magnetic field of multiple types of the first charging standard.

According to an embodiment of the present invention, the transmitter is provided to transmit the second charging magnetic field of multiple types of the second charging standard.

According to an embodiment of the present invention, the wireless charging adapter further comprises a communicating element which is in signal connection with the receiver and the transmitter, and the communicating element being provided to transmit usage information of the receiver and the transmitter and/or receive update information for updating the receiver and the transmitter.

According to an embodiment of the present invention, the wireless charging adapter further comprises an electrical connector, which is provided at the receiver, being used to connect to an external power source so as to receive power from the external power source and then provide the received power as the charging energy to the transmitter.

According to an embodiment of the present invention, the main body is a sticker, a mat or a coaster.

According to an embodiment of the present invention, the main body is a smartphone dock, a smartphone holder, or a smartphone case.

According to an embodiment of the present invention, the main body is a glasses frame, glasses case, or a glasses holder.

According to an embodiment of the present invention, the main body is a headphone/earphone cap, a headphone/earphone holder, or a headphone/earphone case.

By the technical means adopted by the present invention, the wireless standard of the electronic device has become unnecessary to be compatible with the wireless standard of the wireless charger. The wireless charging adapter of the present invention converts the first charging magnetic field of the first charging standard to a different second charging magnetic field of the second charging standard in such a manner it enables the electronic device to be charged by the second charging magnetic field of the second wireless charging standard when the charging standard of the electronic device and the charging standard of the wireless charger are different.

### BRIEF DESCRIPTION OF THE DRAWINGS

FIG. 1 is a schematic diagram of a wireless charging adapter according to a first embodiment of the present invention;

FIG. 2 is a block diagram of the wireless charging adapter while using according to the first embodiment of the present invention;

FIG. 3 is a block diagram of the wireless charging adapter according to a second embodiment of the present invention;

FIG. 4 is a block diagram of the wireless charging adapter according to a third embodiment of the present invention.

### DETAILED DESCRIPTION OF THE PREFERRED EMBODIMENTS

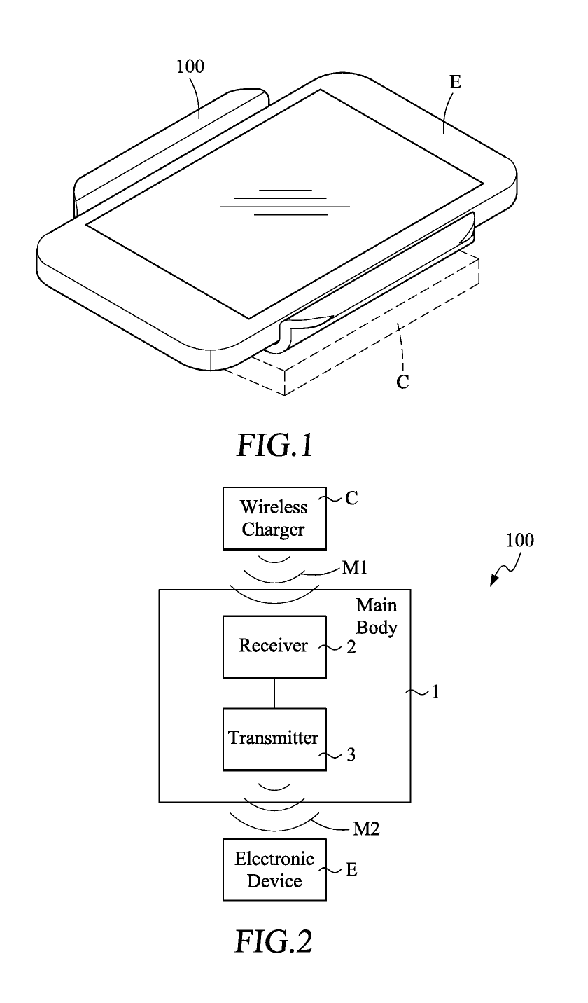

The preferred embodiments of the present invention are described in detail below with reference to FIG. 1 to FIG. 4. The description is used for explaining the embodiments of the present invention only, but not for limiting the scope of the claims.

As shown in FIG. 1 and FIG. 2, a wireless charging adapter 100 according to the first embodiment of the present invention comprises: a main body 1; a receiver 2, which is integrated in the main body 1 and is provided to receive a first charging magnetic field M1 from the outside of the main body 1 by following a first wireless charging standard to convert the first charging magnetic field M1 to a charging energy; and a transmitter 3, which is integrated in the main body 1 and electrically connected to the receiver 2, being provided to convert the charging energy to a second charging magnetic field M2 by following a second wireless charging standard and transmit the second charging magnetic field M2 to the outside of the main body, wherein the first wireless charging standard is different from the second wireless charging standard.

In detail, the wireless charging standard is a regulation that the receiver 2, transmitter 3 and/or charging magnetic field must comply with, such as charging technique (magnetic induction, magnetic resonance or long distance charging), frequency, power, protocol, and circuit layout. The charging magnetic fields of different wireless charging standards vary in power, and/or frequency, and/or protocol.

The receiver 2 has a receiving coil which forms an inductive coupling with a wireless charger C at the outside. The first charging magnetic field M1 of the first wireless charging standard transmitted by the wireless charger C induces a charging energy in the receiver 2. In this embodiment, the receiver 2 can identify the first wireless charging standard used by the wireless charger C and receive the first charging magnetic field M1 of multiple types of the first wireless charging standards so as to convert the first charging magnetic field M1 of various first wireless charging standards and in wide use.

The transmitter 3 has a transmitting coil which can form an inductive coupling with the electronic device E to be charged at the outside. The transmitter 3 can identify the second wireless charging standard used by the electronic device E and convert the charging energy induced by the receiver 2 to the second charging magnetic field M2 of the second wireless charging standard, so as to charge the electronic device E which can be charged by the second charging magnetic field M2 of the second wireless charging standard. In this embodiment, the transmitter 3 can transmit the second charging magnetic field M2 of multiple types of the second wireless charging standards used by the electronic device E and convert the charging energy to the second charging magnetic field M2 of the various second wireless charging standards and in wide use.

The wireless charging adapter 100 according to the first embodiment of the present invention can receive the first charging magnetic field M1 of multiple types of the first wireless charging standards and transmit the second charging magnetic field M2 of multiple second wireless charging standards in such a manner it provides a many-to-many conversion. In other embodiments, it goes without saying that the receiver 2 can convert the first charging magnetic field M1 of one specific first wireless charging standard and/or the transmitter 3 can transmit the second charging magnetic field M2 of one specific second wireless charging standard in such a manner it has simplified circuit structure and provide a one-to-one, one-to-many or many-to-one conversion.

In the wireless charging adapter 100 according to the first embodiment of the present invention as shown in FIG. 1 and FIG. 2, the main body 1 is a cell phone dock. The receiver 2 and the transmitter 3 are disposed in the cell phone dock. The cell phone dock has a groove for accommodating a cell phone. It goes without saying that the present invention is not limit to this. In other embodiments, the main body 1 can be a cell phone holder or a cell phone case designated to charge the cell phone. The main body 1 also can be a demountable glasses frame, a glasses box or a glass holder designated to charge smartglasses. The main body 1 also can be a demountable headphone/earphone cap, a headphone/earphone holder or a headphone/earphone case designated to charge a headphone/earphone. And the wireless charging adapter 100 can be replaced according to changes of the first wireless charging standard of the wireless charger C. The main body 1 can be a flat piece such as a flexible or a hard mat, or other coaster-like device for placing the electronic device E and wirelessly charging the electronic device E through the transmitter 3. The main body 1 also can be a sticker adhered to the electronic device E to be charged, in which the transmitter 3 only needs a function of transmitting the second charging magnetic field M2 of the specific second wireless charging standard. The main body 1 can be a sticker adhered the wireless charger C in which the receiver 2 only needs a function of receiving first charging magnetic field M1 of the specific first wireless charging standard in such a manner it enables the electronic device E to be charged by the second charging magnetic field M2 of the second wireless charging standard.

As shown in FIG. 2, the transmitter 3 is directly electrically connected to the receiver 2 so as to receive the charging energy in real-time and simultaneously convert the charging energy to the second charging magnetic field M2 of the second wireless charging standard which is transmitted to the outside of the main body. The receiving coil and the transmitting coil are plural, and each of which corresponds to the charging magnetic field of the various wireless charging standards respectively. In other embodiments, the receiving coil and/or the transmitting coil can be one coil or an array of the same type of coils.

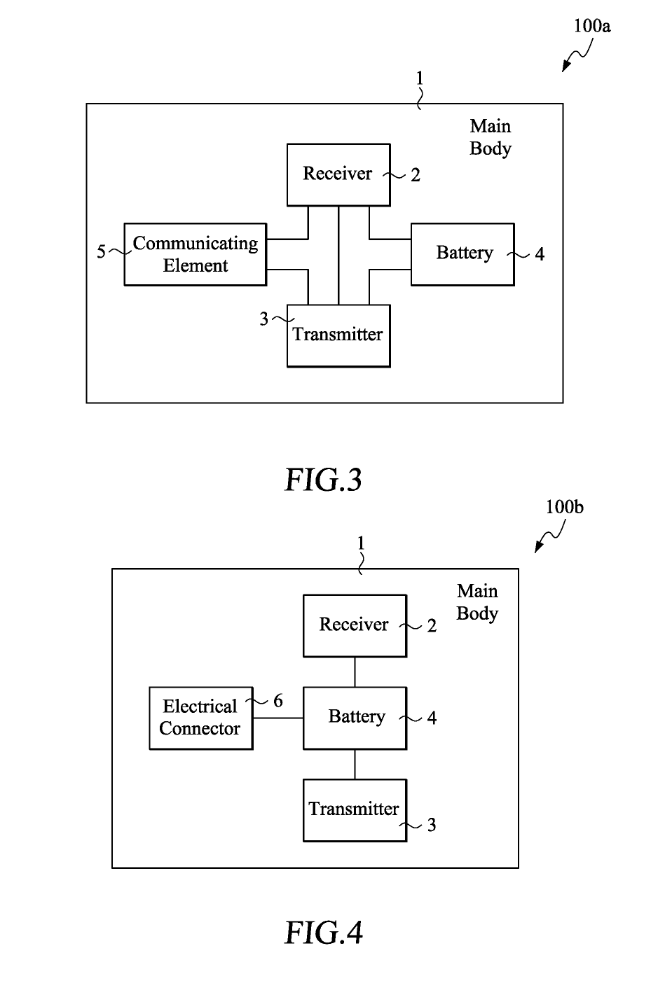

In the wireless charging adapter 100a according to the second embodiment of the present invention as shown in FIG. 3, a battery 4 is electrically connected to the receiver 2 and transmitter 3, and a communicating element 5 is in signal connection with the receiver 2 and transmitter 3. The battery 4 stores the charging energy from the receiver 2 and provides the stored charging energy to the transmitter 3. Accordingly, when the charging energy directly provides to the transmitter 3 by the receiver 2 is insufficient or unstable, the battery 4 can discharge simultaneously and compensate the transmitter 3 for the required charging energy. It goes without saying that when the wireless charging adapter 100a is turned on or in other circumstances, the battery 4 can provide the pre-stored charging energy to the transmitter 3 in such a manner that the wireless charging adapter 100a act as a power bank. The communicating element 5 can be used to transmit the usage information of the receiver 2 and the transmitter 3, such as their self-test result, frequency of usage, and the connected wireless chargers C and electronic devices E. The communicating element 5 also can be used to receive update information for updating the receiver 2 and transmitter 3, so as to expand to include more compatible wireless charging standards or to enhance efficiency, etc.

In the wireless charging adapter 100b according to the third embodiment of the present invention as shown in FIG. 4, the receiver 2 and the electrical connector 6 is electrically connected to the transmitter 3 through the battery 4. The electrical connector 6 is a USB plug that is used for connecting to an external power source to receive power and then provide the received power as the charging energy to the transmitter 3. Thus the wireless charging adapter 100b not only can receive the charging energy by wireless connection, but also can receive the charging energy by wired connection, which has greater flexibility of usage. In this embodiment, the charging energy provided by the receiver 2 and the electrical connector 6 are stored in the battery 4, and all of the charging energy received by the transmitter 3 is provided by the battery 4 to ensure the stability of the received charging energy. In other embodiments, it goes without saying that the electrical connector 6 may be directly connected to the transmitter 3 and provides the charging energy to the transmitter 3.

The above description should be considered as only the discussion of the preferred embodiments of the present invention. A person having ordinary skill in the art may make various modifications to the present invention. However, those modifications still fall within the spirit of the present invention and the scope defined by the appended claims.

What is claimed is:

1. A wireless charging adapter, comprising:
a main body;
a receiver, which is disposed in the main body and is provided to receive a first charging magnetic field from the outside of the main body by following a first wireless charging standard to convert the first charging magnetic field to a charging energy; and
a transmitter, which is disposed in the main body and electrically connected to the receiver, being provided to convert the charging energy to a second charging magnetic field by following a second wireless charging standard and transmit the second charging magnetic field to the outside of the main body,
wherein the first wireless charging standard is different from the second wireless charging standard.

2. The wireless charging adapter as claimed in claim 1, further comprising a battery which is electrically connected to the receiver and the transmitter so as to store the charging energy and provide the stored charging energy to the transmitter.

3. The wireless charging adapter as claimed in claim 1, wherein the receiver is provided to receive the first charging magnetic field of multiple types of the first charging standard.

4. The wireless charging adapter as claimed in claim 2, wherein the receiver is provided to receive the first charging magnetic field of multiple types of the first charging standard.

5. The wireless charging adapter as claimed in claim 1, wherein the transmitter is provided to transmit the second charging magnetic field of multiple types of the second charging standard.

6. The wireless charging adapter as claimed in claim 2, wherein the transmitter is provided to transmit the second charging magnetic field of multiple types of the second charging standard.

7. The wireless charging adapter as claimed in claim 1, further comprising a communicating element which is in signal connection with the receiver and the transmitter, and the communicating element being provided to transmit usage information of the receiver and the transmitter and/or receive update information for updating the receiver and the transmitter.

8. The wireless charging adapter as claimed in claim 2, further comprising a communicating element which is in signal connection with the receiver and the transmitter, and the communicating element being provided to transmit usage information of the receiver and the transmitter and/or receive update information for updating the receiver and the transmitter.

9. The wireless charging adapter as claimed in claim 1, further comprising an electrical connector, which is provided at the receiver, being used to connect to an external power source so as to receive power from the external power source and then provide the received power as the charging energy to the transmitter.

10. The wireless charging adapter as claimed in claim 2, further comprising an electrical connector, which is provided at the receiver, being used to connect to an external power source so as to receive power from the external power source and then provide the received power as the charging energy to the transmitter.

11. The wireless charging adapter as claimed in claim 1, wherein the main body is a sticker or a mat.

12. The wireless charging adapter as claimed in claim 2, wherein the main body is a sticker or a mat.

13. The wireless charging adapter as claimed in claim 1, wherein the main body is a smartphone dock, a smartphone holder, or a smartphone case.

14. The wireless charging adapter as claimed in claim 2, wherein the main body is a smartphone dock, a smartphone holder, or a smartphone case.

15. The wireless charging adapter as claimed in claim 1, wherein the main body is a glasses frame, glasses case, or a glasses holder.

16. The wireless charging adapter as claimed in claim 2, wherein the main body is a glasses frame, glasses case, or a glasses holder.

17. The wireless charging adapter as claimed in claim 1, wherein the main body is a headphone/earphone cap, a headphone/earphone holder, or a headphone/earphone case.

18. The wireless charging adapter as claimed in claim 2, wherein the main body is a headphone/earphone cap, a headphone/earphone holder, or a headphone/earphone case.
